(19) United States
(12) Patent Application Publication
(10) Pub. No.: US 2021/0074461 A1
(43) Pub. Date: Mar. 11, 2021

(54) Impulse difference engine

(71) Applicant: Boris Lagutin, Flushing, NY (US)

(72) Inventor: Boris Lagutin, Flushing, NY (US)

(21) Appl. No.: 17/005,782

(22) Filed: Aug. 28, 2020

Related U.S. Application Data
(60) Provisional application No. 62/897,139, filed on Sep. 6, 2019.

(51) Int. Cl. H01F 7/08; B64G 1/40; H01F 7/06

(52) U.S. Cl. CPC H01F 7/081; H01F 2007/086; H01F 7/064; B64G 1/409

(57) ABSTRACT

A device is for giving a continuous, smooth thrust at a chosen direction of movement by exploiting a difference of initial impulses and final impulses given to rotational sources of magnetic field. Interactions between the magnetic field of the rotational sources and electromagnetic fields generated by stationary sources cause the impulses of various magnitudes and directions. The device is for creating a thrust at any chosen direction. The device does not require any motor. The device is only powered by electricity which may be supplied from solar panels, nuclear reactor, alkaline battery, and other sources.

### CROSS-REFERENCE TO RELATED APPLICATION

This application claims the benefit of provisional patent application No. 62/897,139 filed 2019 Sep. 6 by the present inventor, which is incorporated by reference in its entirety.

### BACKGROUND

### Prior Art

The following is a tabulation of some prior art that presently appears relevant:

U.S. Patents

| Patent Number | Kind Code | Issue Date | Patentee |
|---|---|---|---|
| 8,863,597 | A1 | 2014 Oct. 21 | Plews |
| 3,968,700 | | 1976 Jul. 13 | Cuff |
| 2,009,780 | | 1935 Jul. 30 | Laskowitz |
| 3,807,244 | | 1974 Apr. 30 | Estrade |
| 3,998,107 | | 1976 Dec. 21 | Cuff |

U.S. Patent Application Publications

| Publication Nr. | Kind Code | Publ. Date | Applicant or Patentee |
|---|---|---|---|
| 20060005644 | A1 | 2006 Jan. 12 | Weaver |
| 20060213293 | A1 | 2006 Sep. 28 | Lasch |
| 20070295164 | A1 | 2007 Dec. 27 | Tavarez |

There is a serious problem of orbital garbage which results from human activities around the Earth. The orbital garbage gets satellites, spaceships, International Space Station in danger to encounter the garbage flying at various orbital trajectories at some day. One of the sources of the garbage is old non-functional satellites which cannot be returned to the Earth surface because their limited amounts of propellant for their propulsion systems. Also, the limited amount of propellant is a reason why some satellites cannot be properly operated for a long time.

One constant danger for human civilization is meteorites falling in the Earth atmosphere and able to reach the Earth surface. They may cause multiple casualties and damages of infrastructure. The current orbital spacecraft cannot relatively freely and long patrol the solar system for a reason of the limited amount of fuel or gas. And, they do not have significant thrust to move big dangerous asteroids away from the Earth.

Propulsion systems based on propellant, including ion propulsion systems, require some propellant to function. Usually, a propellant is solid or liquid fuel, or gas. As a result, such propulsion systems can work as long as a propellant storage is available. Moreover, some propellants may cause explosion or fire.

One more problem is that it is extremely expensive to deliver any payload to any orbit of any planet, including the Earth. Hence, delivering propellant for the mentioned propulsion systems is extremely expensive.

Some propulsion systems, which are aimed to give a thrust without a propellant, have been proposed—for example, U.S. Pat. No. 8,863,597 to Plews (2014), U.S. Pat. No. 3,968,700 to Cuff (1976), U.S. Pat. No. 2,009,780 (1935), U.S. Pat. No. 3,807,244 to Estrade (1974), U.S. Pat. No. 3,998,107 to Cuff (1976), U.S. patent 20060005644 to Weaver, Richard Lee (2006), U.S. patent 20060213293 to Lasch et al. (2006), U.S. patent 20070295164 to Tavarez, Harold Ariel (2007). However, such systems require an electromotor or other device to exert a force (or torque) to move parts which directly create thrust. It would appear that additional means (motor or others), which exert a force to make the parts work, may increase a weight (inertial mass) of a satellite or other apparatus. Therefore, the increase enlarges the amount of thrust which is needed to move satellites and other apparatuses. Moreover, additional components (jag-wheels etc.) which are connected to the electromotor may be a reason for more energy consumed. Higher energy may be required because higher forces (torques) may be needed to operate the additional components.

### DRAWINGS—FIGURES

FIG. 1 shows a spinning disk with a rotational source of magnetic field and a bearing assembled in the center of the spinning disk.

FIG. 2 shows the two spinning disks with the rotational sources of magnetic field set on a stationary shaft at their initial position from which the sources begin to rotate because they are given initial impulses perpendicular to a chosen direction of movement.

FIG. 3 shows the two spinning disks with the rotational sources located at one of their possible final positions from which the rotational sources may continue to rotate making a full circle or may completely stop and rotate backward to their initial position.

FIG. 4 shows a stationary disk with a plurality of electromagnets assembled in the stationary disk.

FIG. 5 shows the two spinning disks set on a stationary shaft so that each spinning disk is assembled between the two stationary disks with electromagnets.

FIG. 6 shows a set of the six spinning disks and the seven stationary disks which are assembled on the stationary shaft.

FIG. 7 shows the three pairs of the rotational sources in which each rotational source is assembled on the spinning disk, and the rotational sources in the pair have the same magnitude of their tangential velocity vector which is decreased in a braking zone.

### DRAWINGS—REFERENCE NUMERALS

1 spinning disk
2 bearing
3 rotational source of magnetic field
4 hole in the spinning disk for a stationary shaft
5 stationary shaft
6 rotational sources of magnetic field at their initial position
7 rotational sources of magnetic field at one of their possible final positions
8 stationary disk
9 hole in the stationary disk for the stationary shaft
10 electromagnet assembled in the stationary disk
11 vector of tangential velocity of the rotational source of magnetic field
12 braking zone

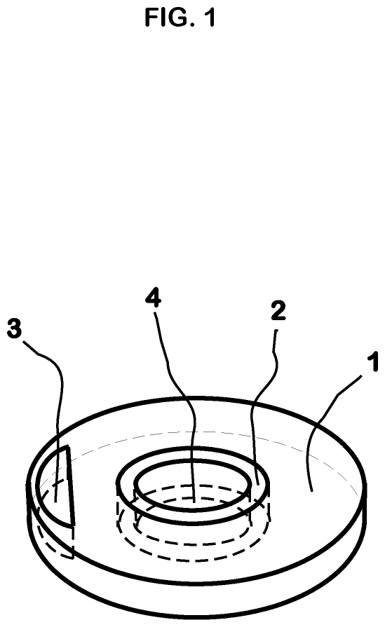

### DETAILED DESCRIPTION—FIGS. 1-5—FIRST EMBODIMENT

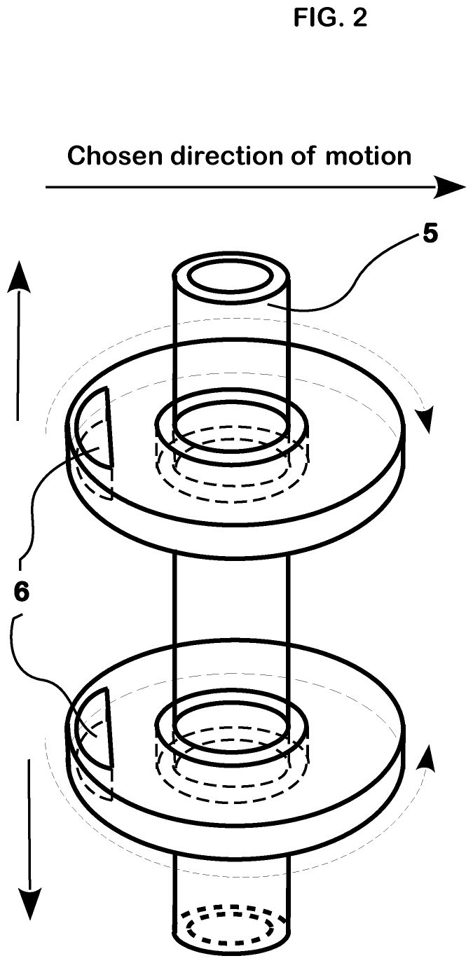

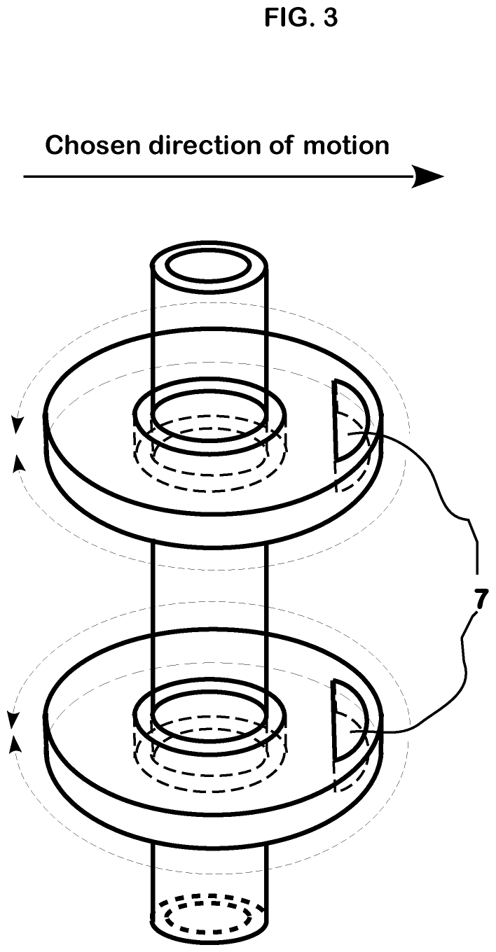

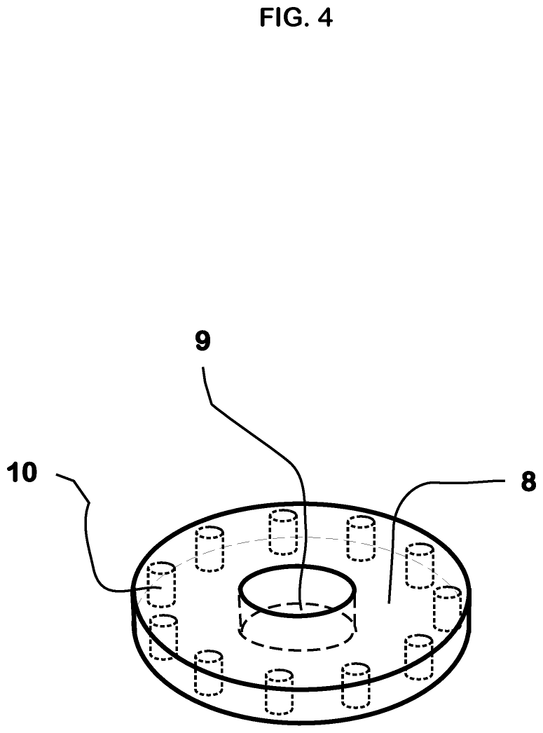

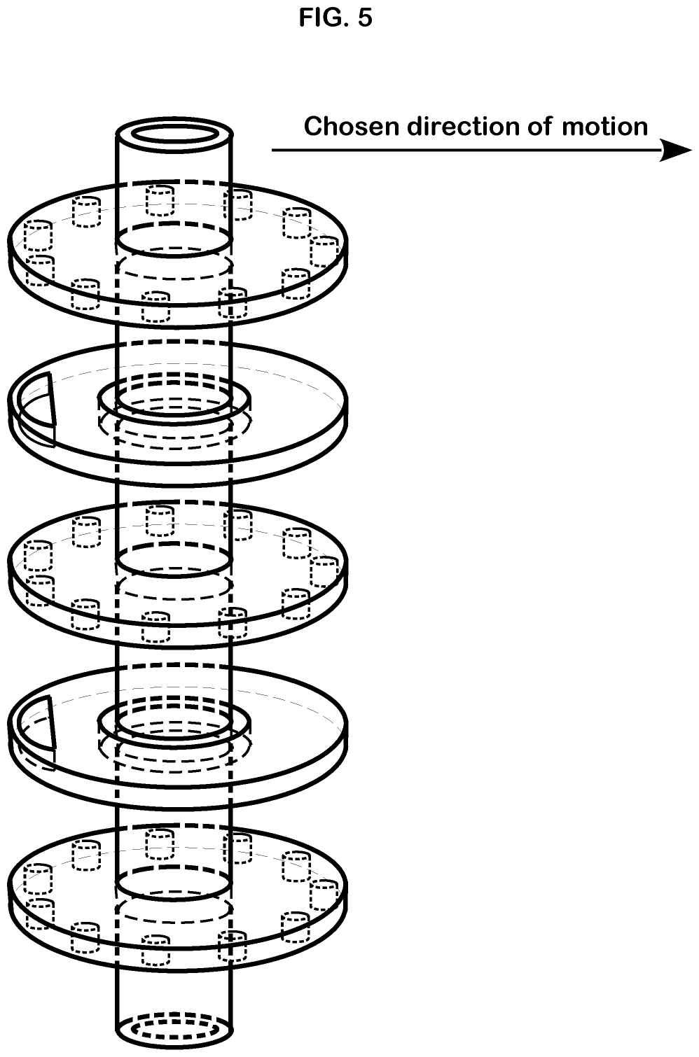

One embodiment of the impulse difference engine is illustrated in FIG. 1, FIG. 2, FIG. 3, FIG. 4, and FIG. 5. The engine has two spinning disks 1, three stationary disks 8 in the embodiment. All the disks are set on a stationary shaft 5 so that each spinning disk 1 is located between the two stationary disks 8. The disks and the stationary shaft may be made of materials that are rigid enough to support the engine functionality. The stationary shaft 5 may be assembled to a satellite or a spaceship, or another apparatus, or inside a closed shell.

At the center of the spinning disk 1 is a bearing 2 at the center of which there is a hole for the stationary shaft 4 which matches the stationary shaft size. At the center of the stationary disk is a hole for the stationary shaft 9 which matches the stationary shaft size. The bearing and the stationary disk may be welded to each other. The bearing may be welded to the stationary shaft. The spinning disk may be welded to the bearing.

Each spinning disk 1 has a rotational source of magnetic field 3 which may have a shape of crescent or any other shape. The rotational source may be less or more than a mass of the spinning disk 1. The rotational source is tightly enough assembled in the spinning disk 1. The stationary disk 8 has a plurality of electromagnets 10. The electromagnets are tightly enough assembled in the stationary disk 8 along the circumference of the stationary disk 8. Each electromagnet 10 may be connected to a controller (computer) with a wire which may come inside the stationary shaft that may be hollow. The electric current may be supplied to the electromagnet 10 at different directions in order to switch the magnetic poles of the electromagnet. A distance between the rotational source 3 and the electromagnets should be enough to rotate the rotational source 3.

### Operation—FIGS. 2, 3, 5

A thrust at a chosen direction of movement is created based on a difference of initial impulses and final impulses given to the rotational sources of magnetic field 3.

To create a thrust at a chosen direction of movement, the two rotational sources of magnetic field 3 are first accelerated from their initial positions 6 at opposite directions by applying accelerating electromagnetic fields (FIG. 2), then the rotational sources 3 are braked completely or incompletely by applying braking electromagnetic fields generated by the electromagnets 10 located at a braking zone 12. Braking the rotational sources 3 is implemented so that the final impulses given to the rotational sources have a magnitude and directions different from those of the initial impulses. In this way, the two spinning disks 1 may spin at incomplete or complete circle (FIG. 3). When the rotational sources return to their initial positions, the rotational sources may be completely stopped by attracting electromagnetic fields, or the rotational sources may be given the new impulses.

The acceleration of the rotational sources 3 located at their initial positions happens so that the vectors of accelerating forces exerted on the rotational sources 3 have at least one component perpendicular to a chosen direction of movement. The electromagnets between which the rotational sources of magnetic field 3 are located at their initial positions create the accelerating electromagnetic fields that exert the accelerating forces on the magnetic fields of the rotational sources 3. The rotational sources 3 being exerted by the accelerating force begin to rotate.

The two rotational sources of magnetic field 3 are used to create a maximum thrust at a chosen direction and avoid creating a thrust at unnecessary directions. The two rotational sources are given the initial impulses that have the same magnitude so that the rotational sources can begin to rotate at opposite directions simultaneously or approximately simultaneously. The rotational sources are braked equally with the same braking forces so that they can get the final impulses of the same magnitude or approximately the same magnitude.

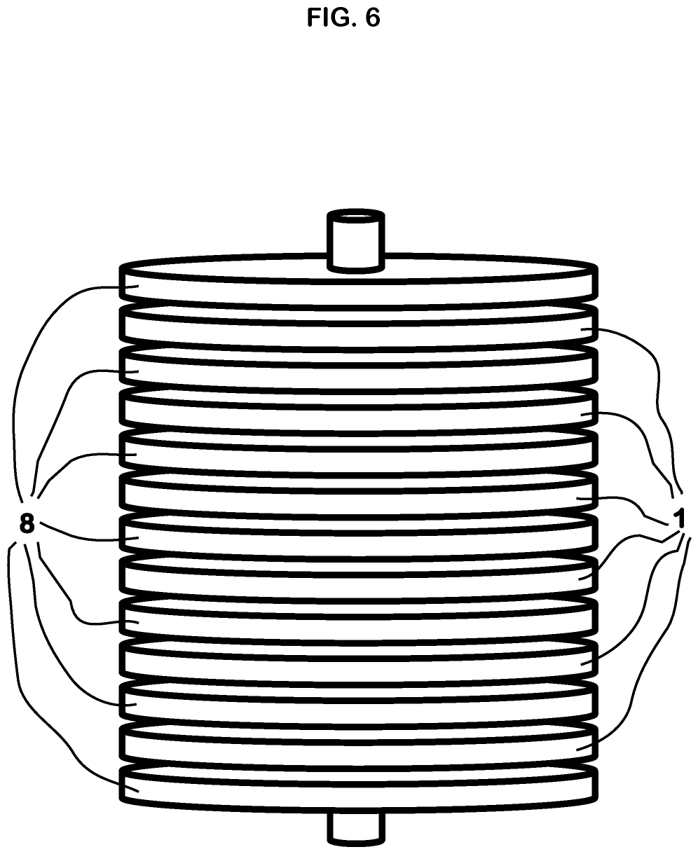

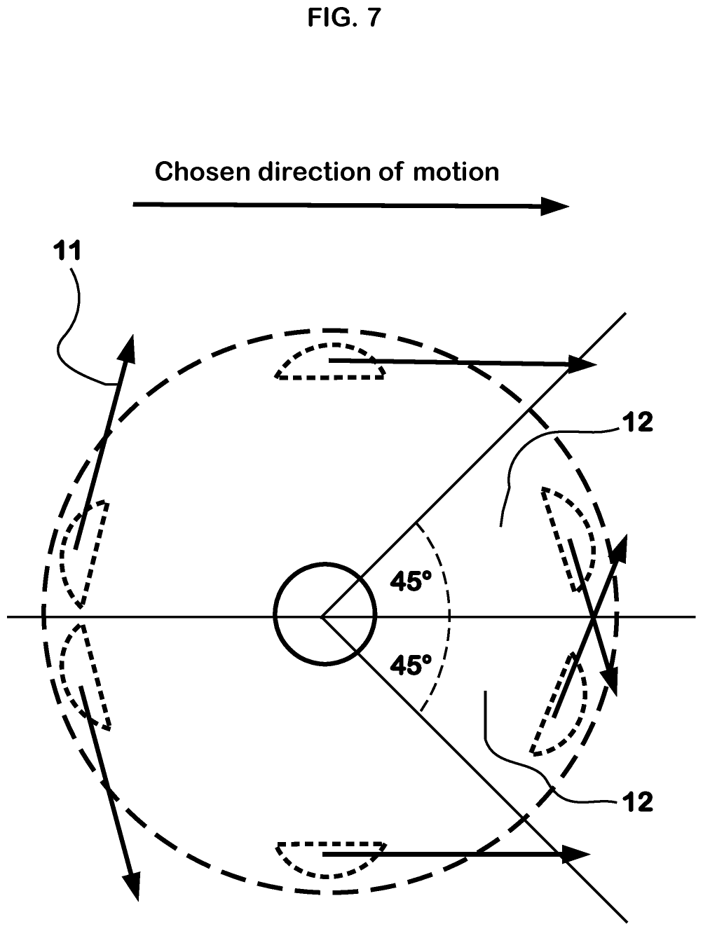

### FIGS. 6-7—Additional Embodiments

At least the six spinning disks 1 are used to create a larger, continuous thrust at a chosen direction of motion. Each two spinning disks begin to rotate simultaneously at opposite directions from their initial positions 6. The pairs of the spinning disks begin to rotate in series—one after another. Each pair is braked at a braking zone 12 of forty five degrees by the electromagnets so that the tangential speeds of the spinning disks decrease (FIG. 7). The number of the electromagnets 10 is not less than eight.

### Alternative Embodiment

Rigid sticks with the rotational sources of magnetic field 3 at the ends of the sticks may be used instead of the spinning disks 1 with the rotational sources of magnetic field 3.

### CONCLUSION, RAMIFICATIONS, AND SCOPE

The first embodiment shows a method to create a thrust at a chosen direction of motion by using the two spinning disks without using any motor or another device to rotate the spinning disks. The additional embodiment has a plurality of at least the six spinning disks which may create a larger and smoother thrust at a chosen direction of motion. The spinning disks may be replaced with the rigid sticks as it is said in the alternative embodiment.

A plurality of the stationary disks, the spinning disks or the rigid sticks may be located inside the spherical shell in vacuum in order to exclude unnecessary aerodynamical effects and water condensation.

I claim:

1. A device for creating a thrust at a chosen direction of motion by interaction of magnetic and electromagnetic fields, and by using a difference of magnitude and direction of initial and final impulses given to rotational sources of permanent magnetic field, comprising:
a) a plurality of spinning and stationary disks which are assembled on a stationary shaft so that each spinning disk is located between the two stationary disks,
b) a plurality of the rotational sources which are fixed to the spinning disks so that the one rotational source is fixed to each spinning disk which can freely spin,
c) a plurality of electromagnets assembled to the stationary disks,
wherein the electromagnets near the rotational sources located at their initial positions generate accelerating electromagnetic fields which exert accelerating forces on the magnetic fields of the rotational sources in order to rotate the rotational sources forward along a chosen direction by giving the initial impulses to the rotational sources, then the electromagnets located at a braking zone generate braking electromagnetic fields in order to brake the rotational movement of the rotational sources, then the braking electromagnetic fields weaken when angular speeds of the rotational sources become less; therefore, the rotational sources, which are given the initial impulses, receive the final impulses which are less than the initial impulses; in this way, a thrust at a chosen direction is created by choosing the initial positions of the rotational sources.

2. The device of claim 1 wherein the accelerating electromagnetic fields begin to simultaneously exert the accelerating forces on at least the two rotational sources so that the two rotational sources begin to rotate at opposite directions at the same angular speeds and at the same time or at approximately the same angular speeds and at approximately the same time; hence, it prevents the stationary disks from spinning when the accelerating electromagnetic fields exert the accelerating forces.

3. The device of claim 1 wherein there are at least the six rotational sources and each two rotational sources begin to simultaneously rotate at opposite directions at the same angular speeds and at the same time or at approximately the same angular speeds and at approximately the same time; in this way, each two rotational sources rotate in series, that is, each pair of the rotational sources begins to follow the other pair with some delay.

4. The device of claim 1 wherein the magnitudes of the final impulses are equal to zero.

5. The device of claim 1 wherein the directions of the vectors of the final impulses are different from the directions of the vectors of the initial impulses.

6. The device of claim 1 wherein the rotational source has a shape of a crescent.

7. The device of claim 1 wherein the stationary shaft is hollow so that there is a space for wires.

8. The device of claim 1 wherein the plurality of the spinning and stationary disks is assembled in vacuum inside a spherical shell which is connected to means to rotate the spherical shell.

9. The device of claim 1 wherein the spinning disks, the stationary disks, and the stationary shaft are made of composite materials.

10. The device of claim 1 wherein the spinning disks, the stationary disks, and the stationary shaft are made of metals.

11. The device of claim 1 wherein the electromagnets are located along the circumference of the stationary disk.

12. The device of claim 1 wherein the electromagnets are connected to a controlling computer.

13. The device of claim 1 wherein the spinning disks are replaced with rotational sticks having the rotational sources on their ends so that each rotational stick has the one rotational source.

14. A method creating a thrust at a chosen direction of motion by exerting accelerating forces perpendicular or approximately perpendicular to a chosen direction of motion on magnetic fields of rotational sources, which are assembled on spinning disks, by applying accelerating electromagnetic fields generated by stationary sources so that then braking electromagnetic fields generated by the stationary sources located in a braking zone exert braking forces to brake the rotational sources, then when the angular speeds of the rotational sources become less, the braking fields are weakened; therefore, final impulses given to the rotational sources become less than initial impulses because at least the one component of the vectors of the final impulses is less than the one of the components of the vectors of the initial impulses, as a result, a difference of the impulses gives a thrust at a chosen direction of motion.

15. The method of claim 14 wherein the braking fields of the stationary sources are consequently turned off after the rotational sources pass each braking field; therefore, it prevents the braking fields from exerting the accelerating forces on the rotational sources while the rotational sources come through the braking zone.

16. The method of claim 14 wherein the weak braking fields exert the weak braking forces on the rotational sources when the rotational sources pass the braking zone.

17. The method of claim 14 wherein the vectors of the initial impulses point at directions perpendicular to a chosen direction of motion.

18. The method of claim 14 wherein the vectors of the initial impulses point at directions approximately perpendicular to a chosen direction of motion.
